(19) United States
(12) Patent Application Publication
(10) Pub. No.: US 2010/0265363 A1
(43) Pub. Date: Oct. 21, 2010

(54) ZOOM LENS OPTICAL SYSTEM

(75) Inventor: Yong Nam Kim, Uiwang-city (KR)

Correspondence Address: CHRISTOPHER PAUL MITCHELL, 888 16TH ST., NW, SUITE 800, WASHINGTON, DC, 20006, US

(73) Assignee: POWER OPTICS CO., LTD, Uiwang-city, Gyeonggi-do (KR)

(21) Appl. No.: 12/742,924

(22) PCT Filed: Oct. 17, 2008
(86) PCT No.: PCT/KR2008/006163

§ 371 Date: May 13, 2010

(30) Foreign Application Priority Data
Nov. 13, 2007 (KR) 10-2007-0115750

(51) Int. Cl. H04N 5/262

(52) U.S. Cl. 348/240.3; 348/E05.055

(57) ABSTRACT

The present invention relates to a zoom (magnification variable) lens optical system that is used for a mobile phone camera or a digital camera. The zoom lens optical system includes, along a light axis in order of arrangement from an object side, a first lens group having a negative refractive power and comprising a prism provided with a reflective surface for bending a light path by reflecting light passed through the first lens at an angle of 90°, a second lens group having a negative refractive power, a third lens group having a positive refractive power, a fourth lens group having a positive refractive power, and a stop, wherein the variation of magnification is performed by moving at least two of the second to fourth lens groups.

### TECHNICAL FIELD

The present invention relates generally to a zoom lens optical system that is suitable for a camera using an image pickup device, and, more particularly, to a zoom lens optical system that is capable of implementing a high magnification variation rate while realizing a reduction in size, desirably compensating for various aberrations, and reducing manufacturing costs by improving mass production performance.

### BACKGROUND ART

In general, a lens optical system that focuses light using an image pickup device such as a Charge-Coupled Device (CCD) or a Complementary Metal-Oxide Semiconductor (CMOS) is configured such that a lens formed to have a large effective aperture and to be bright (to have a low f number) is used as an image pickup lens and an optical filter is inserted between the lens and an image pickup device.

For these reasons, a conventional imaging optical system requires a back focal length greater than an effective focal length, and must be a telecentric optical system in which the chief ray of luminous flux incident from a surrounding image is incident on an image pickup device. Furthermore, since the conventional imaging optical system is configured to bend an optical axis using a prism, the optical full length must be the same both in a wide-zoom mode and in a tele-zoom mode.

In connection with this, U.S. Patent Application Nos. 20060215277 A1 (Sep. 28, 2006), 20060268427 A1 (Dec. 30, 2006), 20070139786 A1 (Jun. 21, 2007), 20070070513 A1 (Mar. 29, 2007) and 20070109661 A1 (May 17, 2007) disclose a 4-group zoom-type zoom lens optical system. Each of the zoom lens optical systems disclosed in the cited prior art includes a first lens group having a positive refractive power, a second lens group having a positive refractive power, a stop (stop diaphragm) having a fixed location, a third lens group having a negative refractive power, and a fourth lens group having a positive refractive power, which are arranged sequentially from an object side. This zoom lens optical system performs the variation of magnification by varying the air space between the second lens group and the third lens group, and performs Automatic Focusing (AF) using the fourth lens group.

This zoom lens optical system has advantages in that the difference in the f number between a wide-zoom mode and a tele-zoom mode is small and the difference in the incident angle of a chief ray incident on a sensor surface, which depends on the height of an image plane, is low, but has problems in that the length of the optical system is longer and the manufacturing sensitivity is high.

Furthermore, U.S. Patent Application No. 20070008626 A1 (Jan. 11, 2007) discloses a 4-group zoom-type zoom lens optical system. The zoom lens optical system disclosed in the cited prior art includes a first lens group having a negative refractive power, a second lens group having a positive refractive power, a third lens group having a positive refractive power, and a fourth lens group having a positive refractive power, which are arranged sequentially from an object side. This zoom lens optical system performs the variation of magnification by driving the second lens group and the fourth lens group and performs Automatic Focusing (AF) by driving the fourth lens group.

This zoom lens optical system enables an optical full length to be shorter, but has a′ problem in that the mass productivity of the third lens group, which is moved in the case of the variation of magnification, is low because the manufacturing sensitivity thereof is very high.

Furthermore, U.S. Patent Application No. 20070070513 A1 (Mar. 29, 2007) discloses a 6 group-type zoom lens optical system. The zoom lens optical system disclosed in the cited prior art includes a first lens group having a positive refractive power, a second lens group having a negative refractive power, a third lens group having a positive refractive power, a fourth lens group having a positive refractive power, a fifth lens group having a negative refractive power, and a sixth lens group having a negative refractive power, which are arranged sequentially from an object side.

This zoom lens optical system has advantages in that aberrations can be desirably compensated for and a low f number can be implemented, but has problems in which the number of component lenses is large, so that high manufacturing costs are incurred and a long optical full length is required.

### DISCLOSURE

### Technical Problem

Accordingly, the present invention has been made keeping in mind the above problems occurring in the prior art, and an object of the present invention is to provide a zoom lens optical system that is capable of reducing the size thereof, implementing a high magnification variation rate, and desirably compensating for various aberrations.

Another object of the present invention is to provide a zoom lens optical system that meets stable design performance and mass production performance, thereby reducing manufacturing costs.

### Technical Solution

In order to accomplish the above objects, the present invention provides a zoom lens optical system, comprising, along a light axis in order of arrangement from an object side, a first lens group comprising a first lens configured to have a negative refractive power and a prism configured to bend a light path by reflecting light passed through the first lens at an angle of 90°, and having a negative refractive power; a second lens group having a negative refractive power; a third lens group having a positive refractive power; a fourth lens group having a positive refractive power; and a stop; wherein variation of magnification is performed by moving at least two of the second to fourth lens groups; and wherein the following Conditional Equations 1 and 2 are satisfied:

$$\begin{matrix}- 0.5 < ( 1 - M 2 ) \times M 3 \times M 4 < - 0.45 & ( 1 ) \\ 0.25 < \frac{ST 3}{OL} < 0.27 & ( 2 )\end{matrix}$$

where M2 is a magnification of the second lens group, M3 is a magnification of third lens group, M4 is a magnification of the fourth lens group, ST3 is a moving distance of the third lens group, and OL is an optical full length, which is a distance between a first surface of an object-side lens of the first lens group and an image plane along an optical axis.

Furthermore, an interval between the fourth lens group and the image plane in a middle-zoom mode is smaller than those in wide-zoom mode and tele-zoom mode.

Here, the stop is moved in conjunction with the third lens group, and, preferably, the stop is disposed between the second lens group and the third lens group.

The zoom lens optical system according to the present invention satisfies the following Conditional Equation 3:

$$3.3 < \vert \frac{FG 1}{FW} \vert < 3.6 \qquad ( 3 )$$

where FG1 is a focal length of the first lens group, and FW is a focal length in a wide-zoom mode.

Furthermore, the zoom lens optical system according to the present invention satisfies the following Conditional Equation 4:

1.45<NdL1<1.55 (4)

where NdL1 is a refractive index of the first lens along a d-line.

Moreover, when a magnification is varied from a value in wide-zoom mode to a value in tele-zoom mode, an interval between the second lens group and the third lens group decreases, an interval between the third lens group and the fourth lens group increases, and the fourth lens group performs an Automatic Focusing (AF) function.

Meanwhile, the first lens has two surfaces that are concave.

### ADVANTAGEOUS EFFECTS

As described above, the zoom lens optical system according to the present invention has the effects of simplifying an inner zoom-type bent optical system to a relative simple construction, implementing a magnification variation rate and easily compensating for various aberrations.

Furthermore, the present invention has the effects of satisfying stable design performance and mass production performance and reducing the manufacturing costs thereof.

### DESCRIPTION OF DRAWINGS

FIGS. 1 to 3 are diagrams showing the optical arrangements of a zoom lens optical system according to a first embodiment of the present invention in wide-zoom mode, middle-zoom mode and tele-zoom mode;

FIGS. 4 to 6 are diagrams showing the optical arrangements of a zoom lens optical system according to a second embodiment of the present invention in wide-zoom mode, middle-zoom mode and tele-zoom mode;

FIG. 7 is an aberration diagram showing the spherical aberration (a), astigmatic field curvature (b) and distortion (c) of the zoom lens optical system according to the first embodiment of the present invention in a wide-zoom mode;

FIG. 8 is an aberration diagram showing the spherical aberration (a), astigmatism (b) and distortion (c) of the zoom lens optical system according to the second embodiment of the present invention in a tele-zoom mode;

FIG. 9 is an aberration diagram showing the spherical aberration (a), astigmatic field curvature (b) and distortion (c) of the zoom lens optical system according to the second embodiment of the present invention in a wide-zoom mode; and

FIG. 10 is an aberration diagram showing the spherical aberration (a), astigmatic field curvature (b) and distortion (c) of the zoom lens optical system according to the second embodiment of the present invention in a tele-zoom mode.

### DESCRIPTION OF REFERENCE NUMERALS OF PRINCIPAL ELEMENTS IN THE DRAWINGS

| | |
|---|---|
| G1: first lens group | G2: second lens group |
| G3: third lens group | G4: fourth lens group |
| Stop: stop | L1: first lens |
| L2: prism | L3 to L8: third to eighth lens |
| IRF: infrared cutoff filter | IMG: image plane |
| Wide: wide-zoom mode | Middle: middle-zoom mode |
| Tele: tele-zoom mode | |

### BEST MODE

Preferred embodiments of the present invention will be described in detail below with reference to the accompanying drawings.

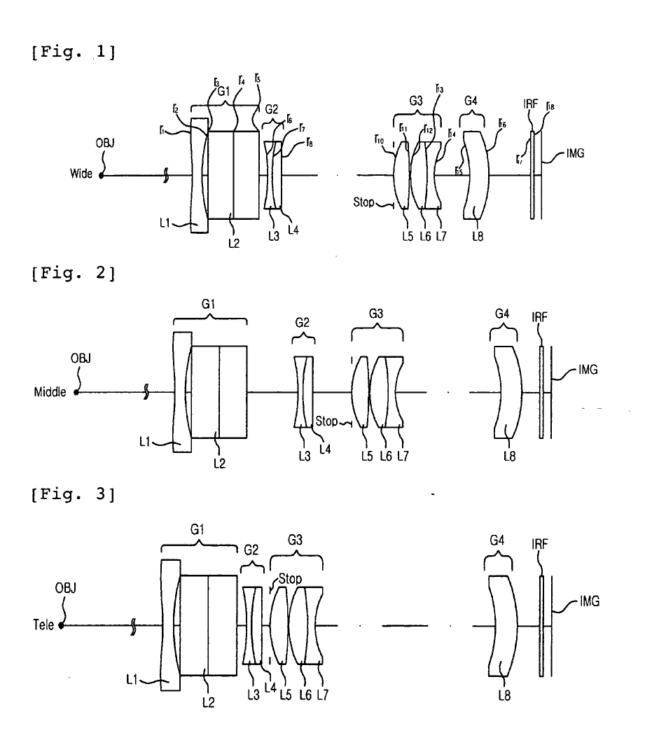

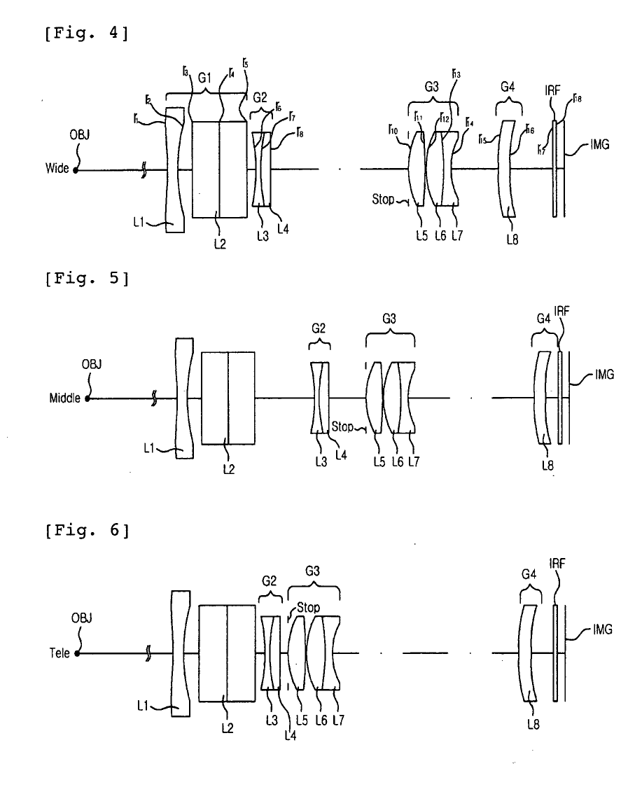

FIGS. 1 to 3 are diagrams showing the optical arrangements of a zoom lens optical system according to a first embodiment of the present invention in wide-zoom mode, middle-zoom mode and tele-zoom mode, and FIGS. 4 to 6 are diagrams showing the optical arrangements of a zoom lens optical system according to a second embodiment of the present invention in wide-zoom mode, middle-zoom mode and tele-zoom mode.

Although in the drawings, four lens groups constituting each of the zoom lens optical systems according to the first and second embodiments of the present invention are illustrated as being disposed along a single straight line, it should be understood that light incident from an object OBJ is bent by a prism and is disposed along two optical axes that are perpendicular to each other.

Meanwhile, in the zoom lens optical system according to the second embodiment, the operation of varying the magnification of each lens group and the number of lenses constituting each lens group are substantially the same as those of the zoom lens optical system according to the first embodiment, but related lens data is varied, as listed in the following Tables 1 to 8.

Referring to FIGS. 1 to 3 and FIGS. 4 to 6, each of the zoom lens optical systems according to the first and second embodiments of the present invention includes a first lens group G1 having a negative refractive power, a second lens group G2 having a negative refractive power, a third lens group G3 having a positive refractive power and a fourth lens group G4 having a positive refractive power, which are arranged sequentially from an object side.

Furthermore, an image pickup device such as a CCD or a CMOS is disposed on an image plane IMG on which an image of the object OBJ passed through the first to fourth lens groups G1 to G4 is formed, and a stop is further provided between the second lens group G2 and the third lens group G3. Here, the stop is disposed such that it can be moved in conjunction with the third lens group, which contributes to a reduction in the size of the entire lens.

At least two of the second to fourth lens groups G2 to G4 are moved along an optical axis to vary magnification, and the fourth lens group G4 or the image plane IMG of the image sensor is moved to calibrate the movement of a focal point. Here, it should be noted that the interval between the fourth lens group G4 and the image plane in the wide-zoom mode and the tele-zoom mode is greater than that in the middle-zoom mode.

It is preferred that the magnifications of the second to fourth lens groups G2 to G4 satisfy the condition of the following Equation 1:

−0.5<(1−M2)×M3×M4<−0.45 (1)

where M2 is the magnification of the second lens group G2, M3 is the magnification of the third lens group G3, and M4 is the magnification of the fourth lens group G4.

The foregoing Equation 1 represents the condition for minimizing manufacturing sensitivity. The value of this equation refers to the amount of deviation of a formed image from the image plane IMG when the second lens group G2 deviates from the optical axis.

With regard to the value of Equation 1, as the absolute value thereof decreases, the manufacturing sensitivity decreases. As the absolute value increases, the manufacturing sensitivity increases. If the value of Equation 1 exceeds the upper limit value, the manufacturing sensitivity decreases but the optical full length increases. In contrast, if the value of Equation 1 exceeds the lower limit value, the optical full length decreases but the manufacturing sensitivity increases.

In this case, the sign of the upper and lower limit values of Equation 1 indicates the direction in which a formed image is deviated. In the case where the signal is a minus sign, it means that an image is formed on the image plane IMG in the direction in which the second lens group G2 deviates from the optical axis.

Furthermore, when the magnification is varied from a value in a wide-zoom mode to a value in a tele-zoom mode, it is preferred that the moving distance of the third lens group G3 and the optical full length satisfy the condition of Equation 2:

$$0.25 < \frac{ST 3}{OL} < 0.27 \qquad ( 2 )$$

where ST3 is the moving distance of the third lens group G3, and OL is an optical full length, which is the distance from the first surface of the object-side lens of the first lens group G1 to the image plane IMG.

Equation 2 represents the correction between the moving distance of the third lens group G3 and the optical full length when the magnification of the third lens group G3 is varied from a value in the wide-zoom mode to a value in the tele-zoom mode.

In the case where the value of Equation 2 exceeds the lower limit value, the moving distance of the third lens group G3 within the optical system is short, so that the efficiency of reducing the optical full length is low. In contrast, in the case where the value exceeds the upper limit value, the moving distance of the third lens group G3 is long, so that it is difficult to ensure the moving distance of each lens group from a mechanical point of view.

Meanwhile, Equation 2 is a condition in which, when the magnification of each of the zoom lens optical systems according to the first and second embodiments of the present invention is varied from a value in wide-zoom mode to a value in a tele-zoom mode, the fourth lens group G4 is moved toward the image plane IMG and is moved toward the object OBJ when the magnification is varied from a value in middle-zoom mode to a value in tele-zoom mode, so that the utilization of the internal space of the optical system is maximized and a large back focal length can be ensured.

Furthermore, in each of the zoom lens optical systems according to the first and second embodiments of the present invention, the first lens group G1 includes a first lens L1 having a negative refractive power and a prism L2 for bending a light path by reflecting light passed through the first lens L1 at an angle of 90°. The first lens group G1 is maintained in a fixed state regardless of the variation of magnification.

Here, it is preferred that the first lens L1 be formed of a plastic lens having at least one aspherical surface, which can desirably compensate for various aberrations between the wide-zoom mode and the tele-zoom mode and can reduce the difference in the f number.

Here, the focal length FG1 of the first lens group G1 and the refractive index of the first lens L1 are optimized when they satisfy respective conditions of the following Equations 3 and 4:

$$3.3 < \vert \frac{FG 1}{FW} \vert < 3.6 \qquad ( 3 )$$

where FG1 is the focal length of the first lens group G1, and FW is the focal length in a wide-zoom mode.

In the case where the focal length of the first lens group G1 exceeds the lower limit value, the diameter (height) of a beam incident on the prism L2 increases, so that the prism L2 increases. In contrast, in the case where the focal length exceeds the upper limit value, the difference in the location and size of an entrance pupil (an opening that is used to determine the passing of light from the point of view of an object side) occurs between a wide-zoom mode and a tele-zoom mode, so that the difference in the f number between a wide-zoom mode and a tele-zoom mode increases.

1.45<NdL1<1.55 (4)

where NdL1 is the refractive index of the first lens on the d-line.

In the case where the refractive index of the first lens L1 exceeds the lower limit value, the interval with the prism L2 as well as the curvature increases, so that the full length and barrel of the optical system may increase. In contrast, in the case where the refractive index exceeds the upper limit value, various aberrations can be desirably compensated for and the full length of the optical system can be reduced, but it is difficult to select both glass and plastic materials as the materials of the first lens L1. The reason for this is that it is difficult to find a plastic material that satisfies Abbe's number in the case where the refractive index is equal to or greater than 1.55.

In order to maximally compensate for the chromatic aberration, the second lens group G2 is formed of a doublet lens in which a third lens L3 having a negative refractive power and a fourth lens L4 having a positive refractive power are attached to each other. When the magnification is varied from a value in wide-zoom mode to a value in tele-zoom mode, the movement from the object side to the image plane side is performed, and then the movement from the image plane side to the object side is performed after passing through the middle-zoom mode. In this case, the second lens group G2 functions to increase the magnification variation rate while decreasing the distance to the third lens group G3.

The third lens group G3 includes a fifth lens L5 configured to have at least one aspherical surface and sixth and seventh lenses L6 and L7 formed of a doublet lens. When the magnification is varied from a value in the wide-zoom mode to a value in the tele-zoom mode, the third lens group G3 is moved from an image plane side toward the object OBJ.

The fourth lens group G4 is formed of an eighth lens L8 that is aspheric and is made of plastic. The fourth lens group G4 functions to adjust the ratio of center to surround illumination in the tele-zoom mode and adjust the chief ray angle depending on the height of incidence on the image plane. The fourth lens group G4 maintains a fixed state in the case of the variation of magnification, and is moved to perform an AF function when the distance to the object OBJ varies.

In the wide-zoom mode, the light path passes through the center of the fourth lens group G4, while in the tele-zoom mode, the light path passes through the front surface of the fourth lens group G4. In this case, the ratio of center to surround illumination in the wide-zoom mode can be adjusted by appropriately controlling the lens effective aperture in the tele-zoom mode.

In this case, as the fourth lens group G4 increases, the ratio of center to surround illumination increases, but the outside diameter of the lens increases. As the fourth lens group G4 decreases, the ratio of center to surround illumination decreases. Therefore, the effective aperture thereof must be determined according to the purposes thereof.

A lens capable of adjusting the chief ray angle depending on the height of light incident on the image plane IMG is finally optimized at a lens closest to the image plane. That is, the fourth lens group G4 is a lens closest to the image plane, and has a function of slightly adjusting the chief ray angle.

Meanwhile, various optical elements may be disposed between the fourth lens group G4 and the image plane depending on the construction of a camera in which lenses are mounted. In the illustrated example of the construction, an Infrared Cutoff Filter (IRF) is disposed therebetween.

The data of respective lenses that constitute the zoom lens optical system of the first embodiment shown in FIGS. 1 to 3 is shown in Tables 1 to 4.

In detail, Table 1 shows the radius of curvature of each surface, thicknesses or the distance between lenses, and the refractive index and Abbe's number as the glass code of material, Table 2 shows the aspheric coefficients of aspherical surfaces 1 to 6 shown in Table 1, Table 3 shows the distance of a part, which belongs to thickness and the distance between lenses shown in Table 1 and is marked with (*), for each zoom location, and Table 4 shows the focal length and view angle for each zoom location.

TABLE 1

| | | Thickness | |
|---|---|---|---|
| | Radius of | or distance | |
| Surface number | curvature | between lenses | Glass code |
| 1 (aspherical surface 1) | −10.168 | 0.68 | 531130.557 |
| 2 (aspherical surface 2) | 22.760 | 0.92 | |
| 3 | ∞ | 2.40 | 804000.466 |
| 4 | ∞ | 2.40 | 804000.466 |
| 5 | ∞ | *0.88 | |
| 6 | −10.200 | 0.45 | 717004.479 |
| 7 | 6.209 | 0.97 | 904000.313 |
| 8 | −155.500 | *7.05 | |
| Stop | ∞ | 0.00 | |
| 10 (aspherical surface 3) | 3.625 | 1.13 | 586470.609 |
| 11 (aspherical surface 4) | −8.104 | 0.10 | |
| 12 | 4.250 | 1.02 | 729160.547 |
| 13 | −16.080 | 0.54 | 904000.313 |
| 14 | 2.350 | *2.68 | |
| 15 (aspherical surface 5) | −7.836 | 1.71 | 531130.557 |
| 16 (aspherical surface 6) | −3.398 | *1.97 | |
| 17 | ∞ | 0.30 | 516798.642 |
| 18 | ∞ | 0.62 | |
| IMG | ∞ | 0.00 | |

TABLE 2

| | Aspherical | Aspherical | Aspherical | Aspherical | Aspherical | Aspherical |
|---|---|---|---|---|---|---|
| | surface 1 | surface 2 | surface 3 | surface 4 | surface 5 | surface 6 |
| R | −1.01683E+01 | 2.27600E+01 | 3.62517E+00 | −8.10418E+00 | −7.83610E+00 | −3.39759E+00 |
| K | −3.99319E+01 | 4.40258E+01 | −1.43365E−01 | −1.79999E+00 | 9.67285E+00 | 3.96310E−01 |
| A | 2.60737E−30 | 6.89316E−03 | −1.73656E−03 | 1.85773E−03 | −1.12049E−03 | 4.14922E−03 |
| B | 5.53881E−05 | −4.01370E−04 | −3.12997E−04 | 1.87075E−04 | 7.88345E−04 | −2.49017E−04 |
| C | −6.92593E−06 | 5.23301E−05 | 9.31882E−05 | 4.06636E−05 | −2.52320E−04 | 2.47873E−04 |
| D | 1.59846E−07 | −2.48030E−06 | −1.01928E−05 | | 7.51993E−06 | −8.33247E−05 |
| E | | | 3.60830E−07 | | 1.71372E−06 | 1.10890E−05 |
| F | | | | | 3.43336E−07 | −4.33993E−07 |

TABLE 3

| Surface number | Wide | Middle | Tele |
|---|---|---|---|
| 5 | 0.880 | 2.920 | 0.886 |
| 8 | 7.050 | 2.437 | 0.550 |
| 14 | 2.683 | 6.132 | 9.747 |
| 16 | 1.969 | 0.945 | 1.398 |

TABLE 4

| | Wide | Middle | Tele |
|---|---|---|---|
| EFL | 3.90 | 6.58 | 11.11 |
| ½ FOV | 31.28 | 19.27 | 11.48 |

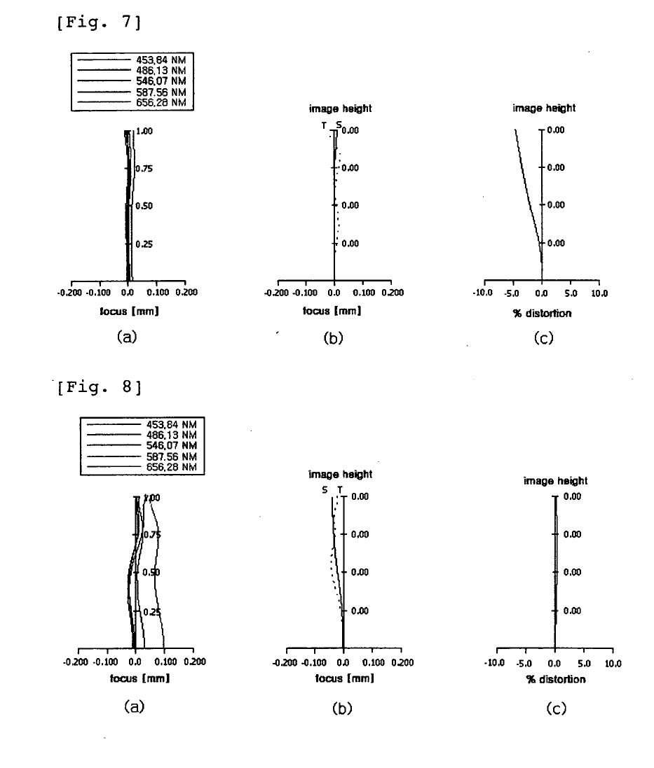

FIG. 7 is an aberration diagram showing the spherical aberration (a), astigmatic field curvature (b) and distortion (c) of the zoom lens optical system according to the first embodiment of the present invention in a wide-zoom mode, and FIG. 8 is an aberration diagram showing the spherical aberration (a), astigmatism (b) and distortion (c) of the zoom lens optical system according to the second embodiment of the present invention in a tele-zoom mode.

That is, FIGS. 7(a) and 8(a) show the spherical aberration of the optical system in the direction of the meridian (the longitudinal direction) with respect to light having various wavelengths. That is, the drawings show aberrations for light having wavelengths of 435.84 nm, 486.13 nm, 546.07 nm 587.56 nm and 656.28 nm with respect to 0.25 image plane, 0.50 image plane, 0.75 image plane and 1.00 image plane. FIGS. 3(b) and 4(b) show the astigmatic field curvature, that is, the tangential field curvature T and the sagittal field curvature S. Furthermore, FIGS. 3(c) and 4(c) show the percent distortion.

Meanwhile, the zoom lens optical system of the second embodiment shown in FIGS. 4 and 6 is different from that of the first embodiment from the aspect of the data of lenses constituting each lens group, which is represented in the following Tables 5 to 8.

In detail, Table 5 shows the radius of curvature of each surface, thicknesses or the distance between lenses, and the refractive index and Abbe's number as the glass code of a material, Table 6 shows the aspheric coefficients of aspherical surfaces 1 to 6 shown in Table 5, Table 7 shows the distance of a part, which belongs to thickness and the distance between lenses shown in Table 5 and is marked with (*), for each zoom location, and Table 8 shows the focal length and view angle for each zoom location.

TABLE 5

| | | Thickness | |
|---|---|---|---|
| | Radius of | or distance | |
| Surface number | curvature | between lenses | Glass code |
| 1 (aspherical surface 1) | −8.796 | 0.84 | 531130.557 |
| 2 (aspherical surface 2) | 39.304 | 1.15 | |
| 3 | ∞ | 2.40 | 755201.2758 |
| 4 | ∞ | 2.40 | 755201.2758 |
| 5 | ∞ | *0.85 | |
| 6 | −10.229 | 0.50 | 714390.4203 |
| 7 | 6.381 | 0.92 | 904000.313 |
| 8 | −121.320 | *7.43 | |
| Stop | ∞ | 0.00 | |
| 10 (aspherical surface 3) | 3.466 | 1.23 | 587982.6212 |
| 11 (aspherical surface 4) | −8.993 | 0.13 | |
| 12 | 4.303 | 1.00 | 725822.4634 |
| 13 | −12.709 | 0.50 | 904000.313 |
| 14 | 2.342 | *2.55 | |
| 15 (aspherical surface 5) | 8.938 | 1.14 | 531130.557 |
| 16 (aspherical surface 6) | −35.489 | *1.90 | |
| 17 | ∞ | 0.30 | 516798.642 |
| 18 | ∞ | 0.71 | |
| IMG | ∞ | 0.01 | |

TABLE 6

| | Aspherical | Aspherical | Aspherical | Aspherical | Aspherical | Aspherical |
|---|---|---|---|---|---|---|
| | surface 1 | surface 2 | surface 3 | surface 4 | surface 5 | surface 6 |
| R | −8.79577E+00 | 3.93041E+01 | 3.46591E+00 | −8.99322E−00 | 8.93758E+00 | −3.54887E+01 |
| K | −2.68892E+01 | 1.28802E+02 | −1.85368E−01 | −1.31205E+00 | 6.99352E+00 | −4.17625E+02 |
| A | 2.38622E−03 | 6.22807E−03 | −2.14779E−03 | 1.72378E−03 | 1.09303E−02 | 1.93690E−02 |
| B | 3.31816E−05 | −2.78372E−04 | 5.82384E−05 | −5.03997E−05 | −4.88971E−04 | −1.30310E−03 |
| C | −7.60084E−06 | 2.72639E−05 | −5.86427E−05 | 8.92143E−06 | −2.29976E−04 | 2.83854E−05 |
| D | 1.60783E−07 | −1.77649E−06 | 1.58911E−05 | | 1.47673E−05 | −9.09483E−05 |
| E | | | −1.54195E−06 | | 1.45444E−06 | 1.33997E−05 |
| F | | | | | −3.77337E−08 | −2.28328E−07 |

TABLE 7

| Surface number | Wide | Middle | Tele |
|---|---|---|---|
| 5 | 0.850 | 2.899 | 0.850 |
| 8 | 7.432 | 2.475 | 0.550 |
| 14 | 2.545 | 6.294 | 9.938 |
| 16 | 1.903 | 1.063 | 1.393 |

TABLE 8

| | Wide | Middle | Tele |
|---|---|---|---|
| EFL | 3.77 | 6.33 | 10.69 |
| ½ FOV | 31.96 | 20.37 | 12.40 |

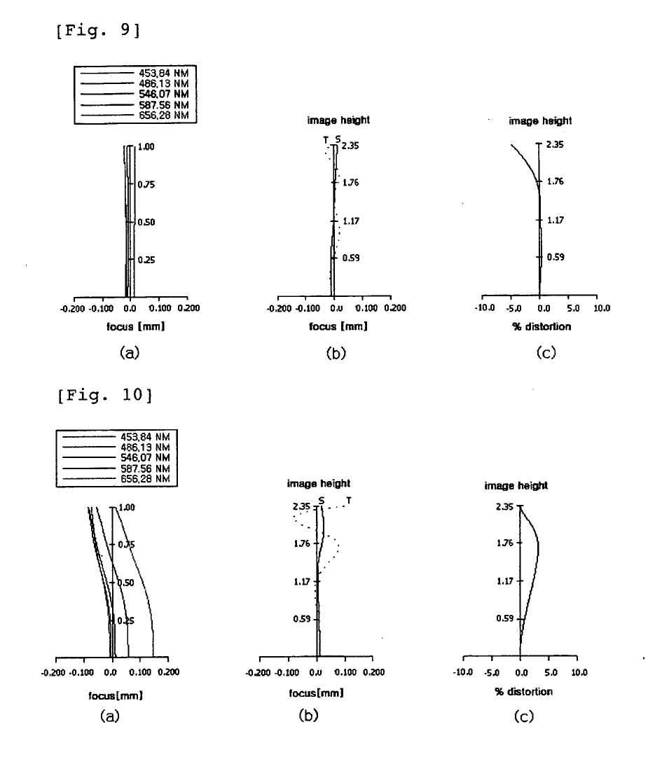

FIG. 9 is an aberration diagram showing the spherical aberration (a), astigmatic field curvature (b) and distortion (c) of the zoom lens optical system according to the second embodiment of the present invention in a wide-zoom mode, and FIG. 10 is an aberration diagram showing the spherical aberration (a), astigmatic field curvature (b) and distortion (c) of the zoom lens optical system according to the second embodiment of the present invention in a tele-zoom mode.

In the zoom lens optical systems according to the first and second embodiments, the aspherical surfaces 1 to 6 of lenses constituting each lens group satisfy the aspheric equation of the following Equation 5:

$$z = \frac{{ch}^{2}}{1 + \sqrt{1 - ( K + 1 ) {c}^{2} {h}^{2}}} + A {h}^{4} + {Bh}^{6} + {Ch}^{8} + {Dh}^{10} + {Eh}^{12} + {Fh}^{14} \qquad ( 5 )$$

where z is a distance from the apex of a lens in the direction of an optical axis, h is a distance in a direction perpendicular to an optical axis, c is the reciprocal of the radius of curvature R at the apex of the lens, K is a conic constant, and A, B, C, D, E and F are aspheric coefficients.

Furthermore, in the zoom lens optical systems according to the first and second embodiments, the values of Equations 1 to 4 are listed in the following Table 9:

TABLE 9

| | Equation 1 | Equation 2 | Equation 3 | Equation 4 |
|---|---|---|---|---|
| First embodiment | −0.496 | 0.251 | 3.355 | 1.531 |
| Second embodiment | −0.458 | 0.265 | 3.556 | 1.531 |

Furthermore, although the zoom lens optical systems according to the first and second embodiments use the prism L2 as a reflective optical element for bending a light path by reflecting light, the reflective optical element is not limited thereto, but may be, for example, a mirror. Since the reflective optical element is constructed with the prism L2, the diameter of a flux passing through the reflective optical system is decreased, so that the size of the prism L2 can be reduced and the thickness of an image pickup apparatus can be reduced.

As described above, although the preferred embodiments of the present invention have been described in the detailed description of present invention, it will be apparent to those skilled in the art to which the present invention pertains that various modifications are possible within a range that does depart from the scope of the present invention. Accordingly, the scope of the rights of the present invention should not be defined only based on the described embodiments, but should be defined based on equivalents of the following claims as well as the following claims.

### INDUSTRIAL APPLICABILITY

The present invention relates to a zoom lens optical system that is suitable for a camera using an image pickup device. The demand for portable electronic devices, such as mobile phones, PDAs and digital cameras, which become smaller, is continuously being created. Accordingly, the need for the zoom lens optical system capable of implementing a high magnification variation rate while reducing the size of the system, desirably compensating for various aberrations, and reducing the manufacturing costs of the system by improving mass production performance will continuously increase.

1. A zoom lens optical system, comprising, along a light axis in order of arrangement from an object side:
a first lens group comprising a first lens configured to have a negative refractive power and a prism configured to bend a light path by reflecting light passed through the first lens at an angle of 90°, and having a negative refractive power;
a second lens group having a negative refractive power;
a third lens group having a positive refractive power;
a fourth lens group having a positive refractive power; and
a stop;
wherein variation of magnification is performed by moving at least two of the second to fourth lens groups; and
wherein the following Conditional Equations 1 and 2 are satisfied:
$$\begin{matrix}- 0.5 < ( 1 - M 2 ) \times M 3 \times M 4 < - 0.45 & ( 1 ) \\ 0.25 < \frac{ST 3}{OL} < 0.27 & ( 2 )\end{matrix}$$
where M2 is a magnification of the second lens group, M3 is a magnification of third lens group, M4 is a magnification of the fourth lens group, ST3 is a moving distance of the third lens group, and OL is an optical full length, which is a distance between a first surface of an object-side lens of the first lens group and an image plane along an optical axis.

2. The zoom lens optical system according to claim 1, wherein an interval between the fourth lens group and the image plane in middle-zoom mode is shorter than those in wide-zoom mode and tele-zoom mode.

3. The zoom lens optical system according to claim 2, wherein the stop is moved in conjunction with the third lens group.

4. The zoom lens optical system according to claim 3, wherein the stop is disposed between the second lens group and the third lens group.

5. The zoom lens optical system according to claim 2, wherein the following Conditional Equation 3 is satisfied:
$$3.3 < \vert \frac{FG 1}{FW} \vert < 3.6 \qquad ( 3 )$$
where FG1 is a focal length of the first lens group, and FW is a focal length in wide-zoom mode.

6. The zoom lens optical system according to claim 5, wherein the following Conditional Equation 4 is satisfied:
1.45<NdL1<1.55 (4)
where NdL1 is a refractive index of the first lens along a d-line.

7. The zoom lens optical system according to claim 5, wherein, when a magnification is varied from a value in a wide-zoom mode to a value in tele-zoom mode, an interval between the second lens group and the third lens group decreases, an interval between the third lens group and the fourth lens group increases, and the fourth lens group performs an Automatic Focusing (AF) function.

8. The zoom lens optical system according to claim 5, wherein the first lens has two surfaces that are concave.
